(19) United States
(12) Patent Application Publication
(10) Pub. No.: US 2022/0205384 A1
(43) Pub. Date: Jun. 30, 2022

(54) Pump Engine for Hydraulic Capsule Pipeline

(71) Applicant: Baha Elsaye Abulnaga, Bellingham, WA (US)

(72) Inventor: Baha Elsaye Abulnaga, Bellingham, WA (US)

(21) Appl. No.: 17/135,904

(22) Filed: Dec. 28, 2020

(51) Int. Cl. F02B 63/06; F04B 17/05; F02B 47/02; F02B 53/06

(52) U.S. Cl. CPC F02B 63/06; F04B 17/05; F04B 2203/06; F02B 53/06; F02B 47/02

(57) ABSTRACT

The invention is a pump engine developed for the purpose of launching and pumping capsules in a hydraulic pipeline. The engine operates on the combustion and explosion of a mixture of fuel and oxygen bearing gases against a liquid piston that passes through a dynamic current turbine. The rotation of the turbine maintains a constant direction of rotation through the oscillation of the water column, and drives a special rotor to feed capsules from a hopper into the pipeline, while the liquid piston pushes them into the pipeline and applies the necessary pressure. The turbine also drives the necessary auxiliaries such as alternator and camshaft for water valves and air inlet and exhaust valves. The pump engine is built in single cylinder or multiple cylinders in duplex and fourplex configurations.

### FIELD OF THE INVENTION

The field of the invention is methods, systems, and devices for transporting sediments or goods in capsules in hydraulic capsules pipelines

### BACKGROUND TO THE INVENTION

The transportation of goods in capsules in pipelines offers an opportunity to move sediments during dredging or mineral concentrate in pipelines in mining, using much lower water amounts than conventional slurry pipelines. Hydraulic capsule pipelines were studied extensively in the 1960's to 1990's particularly to transport coal as coal logs but the industry did not develop a simple pumping system. Most schemes involve numerous locks and valves to feed trains of capsules. Liu (2005) describes two main systems

The multi-lock system the universal solution for hydraulic capsule pipelines involves conveyors, locks around the pump, auxiliary pumps to remove water between trains. Two sets of conveyors feed the pumping system. The partially submerge conveyors bring capsules from a storage facility and enter a water reservoir and enter a Y fitting through valves. Two conveyors feed the Y fitting, but only one branch is filled at a time through the timely opening of locks or valves. Water is not compressible so excess water must be removed using a small recirculating pump at the end of the Y fitting and at the entry of the hydraulic pipeline. By using a minimum of two conveyors the velocity of the conveyors is slowed down. If the capsule velocity in the pipeline is at 3 m/s, each of the two conveyors will move at 1.5 m/s. If four conveyors are used, then each can bring the capsules at the speed of 0.75 m/s.

One of the problems of this system, is that it creates pressure waves each time locks are open and locked. Pulsation dampners must be installed.

A different concept called the pump bypass was developed in the 1960's at the Alberta Research Center in Canada, and further developed at the Capsule Pipeline Research Center, University of Missouri-Columbia, for use in association with coal log pipeline (CLP). This system is suitable as a booster in the hydraulic pipeline when the train of capsule is already in the pipeline. A Y pipe connection featuring a lock on each branch divert the trains of capsules to alternative branch. The system uses 8 valves to convert the energy from a centrifugal pump.

These cumbersome schemes are difficult to install and to transport from site to site, particularly when rapid mobility is needed such as in dredging schemes. The internal combustion liquid piston pump engine is a suitable alternative. The engine was developed by Humphrey (1909). The engine operates on the explosion of a mixture of gaseous fuel and air, and uses an oscillating column as the momentum instead of a flywheel.

Abulnaga (1991) a developed a liquid piston engine that incorporated a constant rotation turbine such as a Savonius rotor or a Darrieus rotor between two cylinders operating in alternating stroke.

Therefore I propose to modify further The Abulnaga engine to provide both the positive displacement of a liquid piston to launch a capsule and the rotary motion to feed capsules on a continuous basis.

### REFERENCES

Abulnaga B. E, 1991. An internal combustion engine featuring the use of an oscillating column and hydraulic turbine to convert energy of fuel—Australian patent 607796
Abulnaga B. E. 2020 “Slurry Systems Handbook” McGraw-Hill—2^{nd} Edition
Humphrey H. A. 1909 “An Internal Combustion Pump and Other Applications of a New Principle”—Proceedings of the Institution of Mechanical Engineers, Vol 77, No-1, 1909, pp 1075-2000
Liu H.2005. Liu H. 2005—Pipeline Engineering—Lewis Publishers (now CRC Press) Boca Ranton, Fla., USA
U.S. Pat. No. 1,272,269 “Utilizing an Expansive Force in the movement of liquid”-Issued Jul. 9, 1918
U.S. Pat. No. 1,274,931 “METHODS OF OPERATING PUMPS”—Issued May 8, 1917
U.S. Pat. No. 1,214,791 Methods of Raising or Forcing Liquids—issued Feb. 6, 1917

### SUMMARY OF THE INVENTION

An internal combustion liquid piston engine and capsule launcher constitutes the invention. The engine operates on a four-stroke cycle for combustion of air and fuel and on four simultaneous steps to capture a capsule from a vibrating hopper into a position within the invention from which it can be propelled under the pressure of the liquid piston. The movement of the water piston through a uni-directional current turbine allows to operate the necessary auxiliaries such as the alternator, or camshafts for air and water valves. The principle of the invention is applied for the construction of single cylinder, or multiple cylinders as duplex and fourplex pump engines to minimize pulsations in the pipeline.

### BRIEF DESCRIPTION OF THE DRAWINGS

FIG. (1) presents the invention in a single cylinder configuration during the inlet stroke in the cylinder, while the capsule is moved from an entry position to an intermediate position in the rotor casing.

FIG. (2) presents the invention with the cylinder in a compression stroke, while the capsule rotor rotates to move the capsule to the launching conduit

FIG. (3) presents the invention with the cylinder in a stroke of explosion followed by expansion of the products of expansion, and while the pipeline valve opens to allow the capsule to enter the pipeline under pressure. The capsule rotor turns to an intermediary position.

FIG. (4) presents the invention with the cylinder in the exhaust stroke, discharging the products of combustion, while allowing fresh water to enter the invention, and while the rotor turns to the top position to accept a new capsule in preparation of a new cycle.

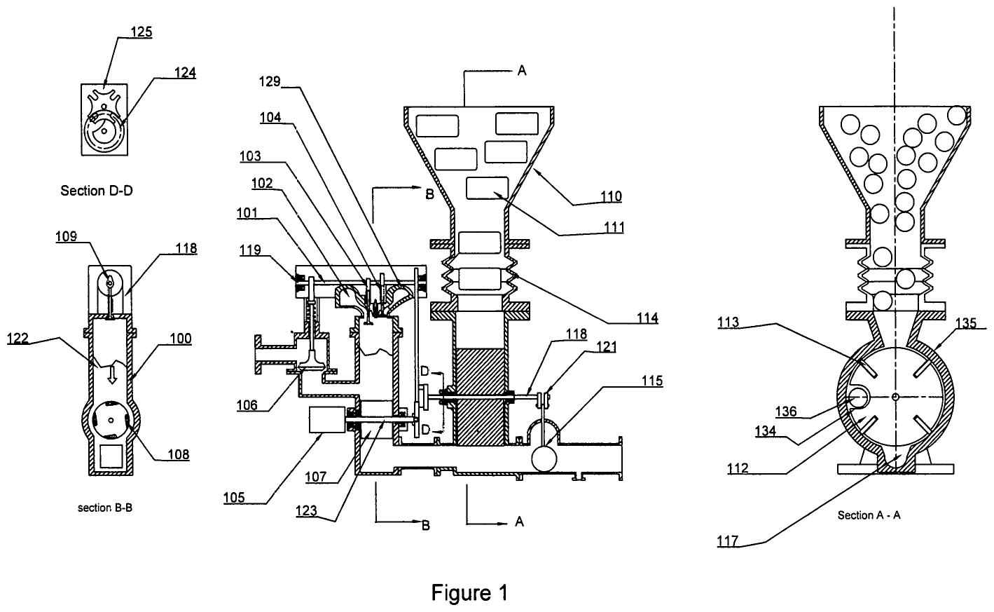

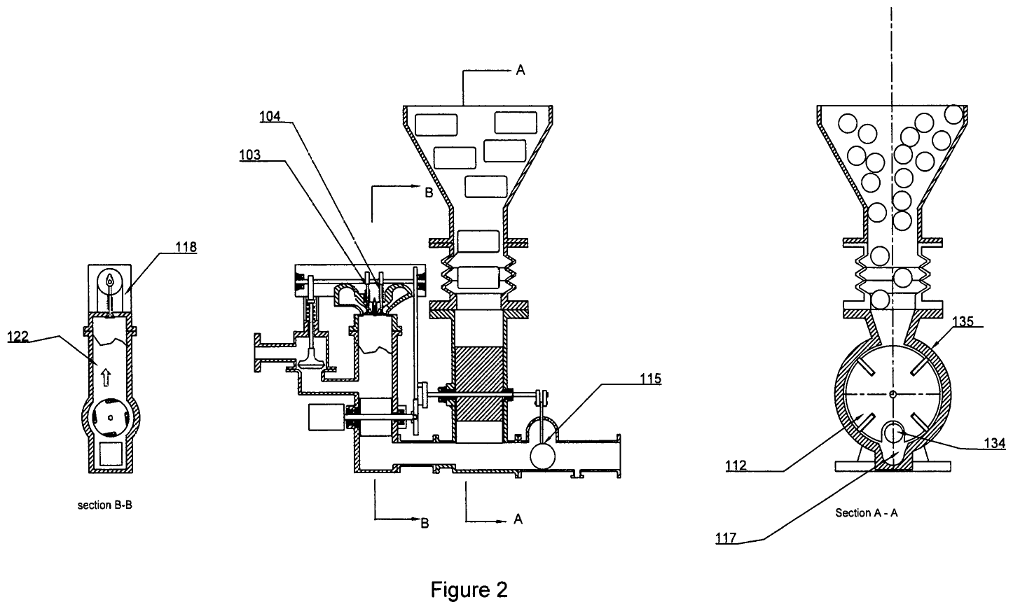

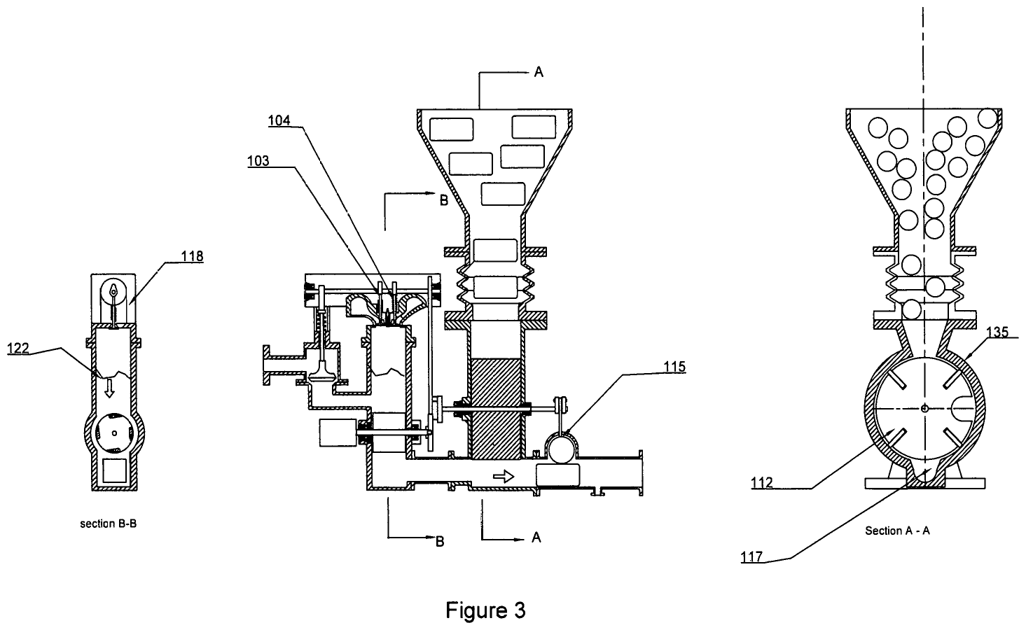

FIG. (5) presents a duplex configuration of the invention with one cylinder in an inlet stroke while the second cylinder is in a compression stroke. The capsule rotor is designed with two slots to handle two capsules at 180° to each others, so that the number of capsules launched is doubled by comparison with FIGS. 1 to 4.

### DETAILED DESCRIPTION OF THE INVENTION

FIG. (1) describes the invented hydraulic capsule pump engine to feed the hydraulic pipeline and pump capsules. This engine can be built as a single cylinder, two cylinders as in a duplex or three cylinders as a triplex. I will start by describing operation in a single cylinder. The engine operates on the Humphrey-Atkinson thermodynamics cycle, while the turbine is of a current type as in the Abulnaga engine.

FIG. (1) shows an embodiment of the invention with a single piston to clarify the combination of liquid piston with turbine.

A cylinder (100) contains the liquid (water) piston ((122). Poppet Valve (103) opens following the entry of fresh air and fuel mixture through conduit (102). During the inlet stroke, the water piston (122) passes through the uni-directional turbine (107), such as a Darrieus or Savonius turbine causing a rotation of the shaft (123). For a Darrieus turbine, the hydrofoil blades (108) of the turbine are set to develop the hydrodynamic thrust forces that maintain constant direction of rotation. The design of the turbine is based on the required tip ratio to convert the vertical speed of the water piston into rotational speed of the turbine.

The turbine shaft (123) is connected to a gear box and speed limiter to drive to a Geneva gear (124) driving a Geneva cross (125). The Geneva cross is of the four-slot design to correspond to the four strokes of the engine to rotate and stop the capsule rotor (112) at each stroke, through shaft (118).

The capsule feeding rotor (112) features at least one slot (134) to move a capsule from the vibrating rotor (110) to the conduit cavity (117). The rotor (112) features sealing vanes (113) to seal water from the cavity (117) to the hopper (110). Typical capsules (111) are fed to the invention from outside sources on a continuous or batch basis. The hopper (110) vibrates through an eccentric driven from shaft (123) through the timing belt or chain (118)

The hopper (110) is connected to the rotor casing (135) through a flexible (114) to allow vibrating the hopper without damaging the pump engine.

The discharge valve (115) is operated by the capsule rotor through a cam (121) mounted on rotor shaft (118). Valve (115) is closed during the engine inlet stroke to prevent water from returning from the pipeline.

The air poppet valves (103) and (104) and water inlet valve (106) are driven from camshaft (119) from the engine shaft (123) through a chain pulley (109) and timing belt or chain (118). An alternator (105) is mounted on the turbine shaft (123) to operate the sparks of the ignition system.

During the stroke of inlet of combustion air, the slot (134) carrying a capsule (136) moves from the top entry at 12 o'clock position, counterclockwise to 9 o'clock. During the inlet stroke the exhaust poppet valve (104) remains closed.

In FIG. (2), the engine is in the compression stroke. The water column (122) reverses direction due to momentum and rises through the turbine and compresses the air and fuel mixture. The turbine (107) continues its rotation in the same direction as the water column rises through the cylinder. The Geneva cross rotates the capsule rotor (112) by 90° the stops to 6 o'clock position. a partial vacuum forms under the rotor (112) and allows the capsule to drop to the bottom into conduit cavity (117). During this stroke, Air poppets valves (103) and (104) remain closed, the water valves (106) and (115) remain closed.

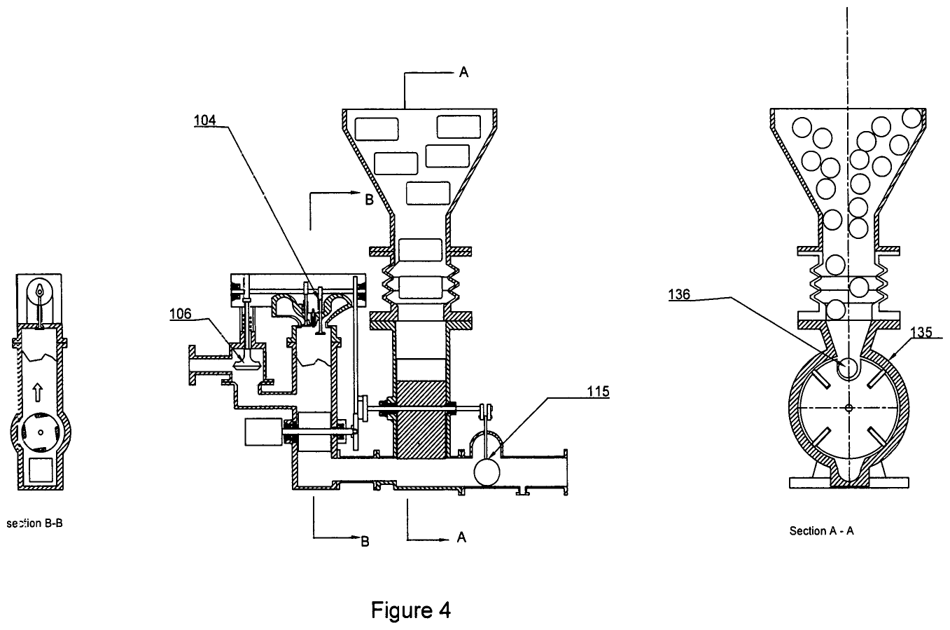

At the end of the compression stroke, the air and fuel mixture are exploded by compression or by a spark. The expansion stroke (FIG. (3)) starts forcing the liquid piston down and opening the pipeline valve (115) and pushing the capsule (136) into the pipeline. The capsule rotor turns by 90° during this stroke to 3 o'clock position. At the end of the expansion stroke, the water column reverses direction by momentum (FIG. 4). The exhaust valve (104) opens to let the products of combustion out of the pump engine through conduit (129). Valve (115) shuts down, while water enters the cylinder (100) through a dedicated valve (106). Rotor (112) rotates to 0 o'clock and a new capsule (136) enters the slot.

The operation of a positive displacement pump engine causes pulsations in the pipeline. They can be attenuated by building a duplex capsule pump engine with two cylinders operating out of phase. An example of the proposed invention as a duplex pump engine is shown in FIG. (5) with two cylinders (A) and (B). Cylinder (A) is in an expansion stroke, while cylinder (B) is in an inlet stroke. Water Valves (225) in cylinder (A) remain closed during the expansion phase in cylinder. Inlet valve (211B) in cylinder (B) opens allowing fresh air in. Water valve (204) closes slowly.

In FIG. (5), the rotor (219) includes two slots (227) and (228) at 180 degrees to each other, so that the rotor can be charged with capsule (232) at the top of the pump engine from the vibrating hopper (213) while discharging capsule (231) into conduit cavity (222). Sealing vanes (221) in the rotor, seal the vibrating hopper (213) from pressurized water from the pump engine.

At the mixture of air and fuel expands in cylinder A, the gate (208) slides open closing the passage to cylinder B, while opening the passage from cylinder A to the cavity (222) to push the capsule (231) already in the cavity (222) into the pipeline by opening the check valve (220).

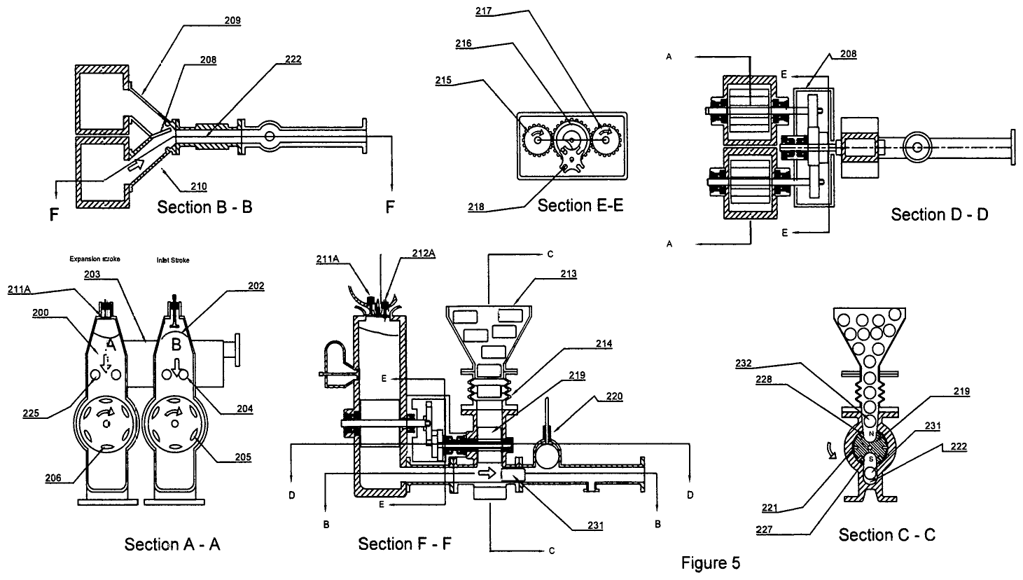

In FIG. 5, section E-E, the Geneva cross (218), is driven through a Geneva cam (216) driven by gear (217) mounted on turbine (206) and gear (215) mounted on turbine (205).

At the end of the expansion stroke in cylinder (A), pipeline check valve (220) closes to prevent a return of water or capsule from pipeline. The water piston retracts into cylinder A passing through turbine (206) that maintains its direction of rotation. Exhaust valve (212A) opens to let the products of combustion leave cylinder (A) while the water valve (225) starts to open to fill the vacuum. Valve (211A) remains closed. Simultaneously, the compression stroke starts in cylinder (B), while valves (211 B), (212B) and (204) are closed. The rotor turns by 90 degrees and stops, positioning the new capsule (232) halfway between inlet at the top and discharge at the bottom.

In the following stroke, it is the inlet stroke for cylinder A, the exhaust valve (212A) closes, air inlet valve (211A) opens, allowing fresh air into cylinder A, water valve 225 closes, while the air fuel mixture in cylinder B undergoes an explosion followed by an expansion. Meanwhile the rotor turns by 90 degrees and stops allowing the capsule (232) to drop into cavity (222) from N slot, and a new capsule enters from the vibrating hopper in the opposing rotor slot. Gate 208 swivels closing passage to cylinder A as water passes from cylinder B to cavity (222) under the rotor. Pipeline valve 220 opens as the water piston from cylinder A pushes the capsules into the pipeline.

In the following stroke, the liquid column starts to return by momentum into cylinder B. The exhaust valve (212B) starts to open to allow the products of combustion to leave. Water valve (204) starts to open to allow some water to enter and fill the vacuum created by expulsion of the products of combustion. The rotor turns by 90°. Simultaneously cylinder A undergoes its compression stroke with valves 211B,212B and 204 closed. The pipeline valve 220 closes.

The cycle is then repeated.

What is claimed is:

1: A pump engine to launch and pump capsules full of sediments, mineral concentrate or goods in a dedicated hydraulic capsule pipeline, consisting of four sections:—
A first section or source of propelling power for the combustion of a mixture of gaseous fuel and air in a cylinder over a liquid piston, through a hydraulic turbine capable of maintaining constant direction of rotation during movement and reverse movement of the liquid piston such as Savonius or Darrieus rotor on its passage to a chamber for launching the capsule
A second section of the capsule pump engine, where capsules enter from a vibrating hopper, and are placed in the slot of a rotor for rotating capsules into a position suitable for launching into a hydraulic capsule pipeline under the pressure of the liquid piston from the fist section, with the said capsule rotor is sealed by peripheral sliding vanes.
A third intermediate section between the turbine and the capsule rotor consisting of a gearbox, Geneva gear mechanism to drive the rotor in the second section, a crankshaft, camshaft to control the position and movement of air valves for the cylinder, water valves, and rotor for the capsules and pipeline check valve.
A fourth section consisting of a conduit connection between the first and second section and featuring a cavity under the rotor for liquid piston to propel capsules from the rotor through a discharge valve, operated by a camshaft from the rotor.

2. A hydraulic capsule pump engine as described in claim 1, where operation is completed in following strokes consisting of
a) A first stroke where fresh air and fuel gas is admitted into the cylinder, through an inlet valve, while the piston rescinds through the turbine, and where the rotor in the second section carrying the capsule turns by 90 degrees from the top entry, and during the said stroke, the water inlet valve remains closed, the cylinder exhaust valve remains closed and the invention pipeline discharge valve remains closed.
b) A second stroke where the air and fuel inlet valves close, the water inlet valve of the first section remains closed and the liquid piston rises to complete compression of the air and fuel mixture in the cylinder, while the capsule rotor turns by 90 degrees moving the capsule inside the second section to bring the capsule above a launching cavity, while sealing the water flow back into the vibrating hopper through sliding vanes in the rotor and while the system discharge valve remains closed preventing a return of water from the discharge pipeline
c) a third stroke starting with the explosion of the air and fuel mixture at the end of the compression stroke, followed by an expansion of the products of combustion pushing the liquid piston through the turbine, against the capsule in the fourth section and forcing it into the pipeline by opening the pipeline water discharge valve, while the rotor in the second section turns by 90 degrees and continues to seal the vibrating hopper.
d) a fourth stroke where the exhaust valve of the cylinder opens to allow the products of combustion to leave the cylinder as the liquid piston rises through the turbine by the oscillation movement, the pipeline discharge valve closes, the rotor in the second section turns by 90 degrees to be in a position to accept a new capsule from the vibrating hopper, while the engine water inlet valve opens to allow a fresh quantity of water to enter the first section.

3. A Duplex internal combustion liquid piston capsule pump launcher as described in claims 1 and 2, consisting of two cylinders A and B for liquid pistons interconnected hydraulically through turbines and a timing mechanism, such as a Geneva gear to a common capsule transfer rotor featuring two slots at 180 degrees of each other to process two capsules, allowing one capsule to enter from the vibrating hopper while releasing another capsule for launching in the pipeline, and whereby the liquid pistons in the two cylinders operate in different strokes in the following arrangement:
A first step when Cylinder “A” or first cylinder undergoes an explosion of air and fuel mixture followed by expansion stroke while Cylinder “B” or parallel cylinder undergoes an inlet stroke admitting fresh air and fuel, with the rotor turning to position the first capsule in a cavity underneath, where the liquid piston from cylinder “A”, or first cylinder pushes the capsules into the hydraulic pipeline propelled through a invention pipeline discharge valve, and where a diverting gate separate the flow from cylinders, maintaining the rotation of the gear mechanism driving the rotor and pump engine auxiliaries such as valves or magneto
A second step whereby the first or Cylinder “A” undergoes the exhaust stroke expulsing the products of combustion and allowing a limited amount of water to enter the cylinder through a dedicated side water valve, while Cylinder “B”, or second cylinder undergoes a compression stroke of the air and fuel mixture by the momentum of the liquid piston, while the pipeline discharge check valve shuts down, and the capsule rotor turns by 90 degrees moving a new capsule to an intermediary location between feed and discharge followed by a stop
A third step where Cylinder “A”, or first cylinder is in an inlet stroke allowing fresh air and fuel to enter, while cylinder “B”, or second cylinder undergoes an explosion of the air and fuel mixture following by an expansion forcing the liquid piston through the turbine towards discharge, while the capsule rotor turns by 90 degrees delivering a capsule that is pushed by the pressure from the liquid piston from cylinder “B” into the pipeline while the discharge valve opens, and while a new capsule enters the rotor to fill the top slot from the vibrating hopper
A fourth step where air valves in cylinder “A”, or first cylinder close, and compression of the air and fuel mixture develops while cylinder “B”, or second “cylinder” is subject to an exhaust stroke, expulsing the products of combustion through exhaust valves and allowing a limited amount of water to enter through a dedicated water valve by the side of cylinder “B”, while the capsule rotor turns by 90° and stops bringing the new capsule into an intermediary position in preparation for launching in the next stroke.

4. A fourplex internal combustion liquid piston pump engine operating on the principles described in claim 3, whereby one cylinder is in an inlet stroke, a second cylinder is in a compression stroke, a third cylinder is in an explosion/expansion stroke, and the fourth cylinder in an exhaust stroke, with the rotor including four slots to handle four capsules, so that one capsule is launched each time a cylinder of the four cylinders undergoes an expansion stroke, and with diverting valves to divert the flows from the individual cylinder into the common launching conduit under the capsule rotor.
